(19) United States
(12) Patent Application Publication
(10) Pub. No.: US 2026/0066641 A1
(43) Pub. Date: Mar. 5, 2026

(54) ELECTRICAL POWER CONTROL DEVICES AND RELATED METHODS

(71) Applicant: ABB SCHWEIZ AG, Baden (CH)

(72) Inventors: Abhinav Patni, Raleigh, NC (US); Sheng Zhong, Hillsborough, NC (US)

(21) Appl. No.: 18/824,874

(22) Filed: Sep. 4, 2024

(51) Int. Cl. H02H 3/08; H02H 1/00

(52) U.S. Cl. CPC H02H 3/08; H02H 1/0007

(57) ABSTRACT

Electrical power control devices may include a main relay coupled to an input power connection, a main power connection for transmitting electrical power from the main relay to a disconnect panel, an auxiliary power connection for transmitting electrical power from the main relay to an auxiliary device that can function as a current load or a current source, an auxiliary relay coupled to the auxiliary power connection, and a data collection and control module coupled to the main relay and the auxiliary relay. The data collection and control module may be configured to selectively open and close the main relay and to selectively open and close the auxiliary relay depending on whether the auxiliary device functions as a current load or a current source. Various other related devices, systems, and methods are also disclosed.

### BACKGROUND

The increasing popularity of electric vehicles (EVs) or other auxiliary electrical devices has led to a rise in energy use in homes. This higher power usage, including from homes with EV chargers, can benefit from electrical power data monitoring. Such monitoring systems may be helpful in comprehending energy use patterns and improving overall consumption. The data obtained can offer homeowners useful details about their energy use, allowing them to better control power and balance between everyday electricity needs and auxiliary demands (e.g., EV charging demands). Higher energy bills can often result from increased electrical loads, making power data monitoring a helpful consideration for homeowners who have auxiliary electrical needs. These monitoring systems can also support utility companies in handling grid load more efficiently, helping avoid power outages or fluctuations that could disrupt service.

### BRIEF SUMMARY

In some aspects, the techniques described herein relate to an electrical power control device, including: a main relay coupled to an input power connection; a main power connection for transmitting electrical power from the main relay to a disconnect panel; an auxiliary power connection for transmitting electrical power from the main relay to an auxiliary device that can function as a current load or a current source; an auxiliary relay coupled to the auxiliary power connection; and a data collection and control module coupled to the main relay and the auxiliary relay, wherein the data collection and control module is configured to selectively open and close the main relay and to selectively open and close the auxiliary relay depending on whether the auxiliary device functions as a current load or a current source.

In some aspects, the techniques described herein relate to a device, wherein the data collection and control module is further configured to open or maintain open the main relay and close or maintain closed the auxiliary relay when the auxiliary device functions as a current source.

In some aspects, the techniques described herein relate to a device, wherein the data collection and control module is further configured to close or maintain closed the main relay and close or maintain closed the auxiliary relay when the auxiliary device functions as a current load.

In some aspects, the techniques described herein relate to a device, further including an input disconnect coupled to the input power connection.

In some aspects, the techniques described herein relate to a device, further including an auxiliary disconnect coupled to the auxiliary power connection.

In some aspects, the techniques described herein relate to a device, wherein the auxiliary device includes at least one of: an electric vehicle charging station; an electric vehicle; a battery; or a generator.

In some aspects, the techniques described herein relate to a device, wherein: the auxiliary power connection includes one or more hot lines; and the auxiliary relay is coupled to a hot line of the one or more hot lines of the auxiliary power connection.

In some aspects, the techniques described herein relate to a device, wherein the data collection and control module is further configured to close or maintained closed the auxiliary relay and open or maintain open the main relay when an outage from the input power connection occurs and power to the input power connection is halted.

In some aspects, the techniques described herein relate to a device, wherein the data collection and control module is further configured open the auxiliary relay and close the main relay when the outage is resolved and power to the input power connection is restored.

In some aspects, the techniques described herein relate to a device, further including a housing containing the main relay, auxiliary relay, and data collection and control module.

In some aspects, the techniques described herein relate to a device, wherein the housing is separate from a meter socket.

In some aspects, the techniques described herein relate to a device, wherein the housing further contains a power meter.

In some aspects, the techniques described herein relate to an electrical power control device, including: a main relay coupled to an input power connection; a main power connection for transmitting electrical power from the main relay to a disconnect panel; an auxiliary power connection for transmitting electrical power from the main relay to an auxiliary device; an auxiliary relay coupled to the auxiliary power connection; an input current sensor configured to sense an input electrical current flowing through the input power connection; a main current sensor configured to sense a main electrical current flowing through the main power connection; an auxiliary current sensor configured to sense a second electrical current flowing through the auxiliary power connection; and a data collection and control module coupled to the main relay, the auxiliary relay, the input current sensor, the main current sensor, and the auxiliary current sensor, wherein the data collection and control module is configured to selectively open and close the main relay and to selectively open and close the auxiliary relay depending on whether the auxiliary device functions as a current load or a current source.

In some aspects, the techniques described herein relate to a device, wherein the data collection and control module is further configured to open the auxiliary relay when a total current flowing through at least one of the input power connect, the main power connection, or the auxiliary power connection reaches or exceeds a predetermined safety threshold.

In some aspects, the techniques described herein relate to a device, wherein the predetermined safety threshold is between 50 percent and 95 percent of a maximum ampacity rating of the input disconnect.

In some aspects, the techniques described herein relate to a device, wherein the predetermined safety threshold is between 70 percent and 95 percent of a maximum ampacity rating of the input disconnect.

In some aspects, the techniques described herein relate to a device, wherein the data collection and control module further includes a communication module configured to send information based on data from the input current sensor, the main current sensor, and the auxiliary current sensor to a user device.

In some aspects, the techniques described herein relate to a method of forming an electrical power control device, the method including: coupling a main relay to an input power connection; coupling a main power connection to the main relay for electrically connecting to a disconnect panel; coupling an auxiliary power connection to the main relay for electrically connecting to an auxiliary device; coupling an auxiliary relay to the auxiliary power connection; and coupling a data collection and control module to the main relay and to the auxiliary relay such that the data collection and control module is configured to selectively open and close the main relay and to selectively open and close the auxiliary relay depending on whether the auxiliary device functions as a current load or a current source.

In some aspects, the techniques described herein relate to a method, further including: coupling an input current sensor to the input power connection to sense an input electrical current flowing through the input power connection; coupling a main current sensor to the main power connection to sense a main electrical current flowing through the main power connection; and coupling the data collection and control module to the input current sensor and the main current sensor such that the data collection and control module can receive data from the input current sensor and the main current sensor.

In some aspects, the techniques described herein relate to a method, further including: coupling an auxiliary current sensor to the auxiliary power connection to sense an auxiliary electrical current flowing through the auxiliary power connection; and coupling the data collection and control module to the auxiliary current sensor such that the data collection and control module can receive data from the auxiliary current sensor.

### BRIEF DESCRIPTION OF THE DRAWINGS

FIG. 1 is a schematic diagram of a power supply system that includes an electrical power control device, according to at least one embodiment of the present disclosure.

FIG. 2 is a schematic diagram of a power supply system that includes an electrical power control device, according to at least one additional embodiment of the present disclosure.

FIG. 3 is a schematic diagram of a power supply system that includes an electrical power control device, according to at least one further embodiment of the present disclosure.

FIG. 4 is a schematic diagram of a power supply system that includes an electrical power control device, according to at least one additional embodiment of the present disclosure.

FIG. 5 is a flow diagram illustrating a method of operating an electrical power control device, according to at least one embodiment of the present disclosure.

FIG. 6 is a schematic diagram of an electrical power control device, according to at least one embodiment of the present disclosure.

FIG. 7 is a flow diagram illustrating a method of forming an electrical power control device, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure provides detailed descriptions of electrical power control devices that can manage the electrical power usage of systems that include a main branch (e.g., to a main disconnect panel and associated devices) and an auxiliary branch for one or more auxiliary devices. As will be explained in greater detail below, some embodiments of the present disclosure may include electrical power control devices that include a main relay coupled to an input power connection, a main power connection for transmitting electrical power from the main relay to a disconnect panel, an auxiliary power connection for transmitting electrical power from the main relay to an auxiliary device, and an auxiliary relay coupled to the auxiliary power connection. A data collection and control module may be coupled to the main relay and the auxiliary relay. The data collection and control module is configured to selectively open and close the main relay and to selectively open and close the auxiliary relay depending on whether the auxiliary device functions as a current load or a current source. Such devices may be helpful to monitor, manage, and control power flow in power systems that include an auxiliary device, including prioritizing power flow and adjusting to auxiliary devices that can function as a load, a source, or both a load and a source.

Features from any of the embodiments described herein may be used in combination with one another in accordance with the general principles described herein. These and other embodiments, features, and advantages will be more fully understood upon reading the following detailed description in conjunction with the accompanying drawings and claims.

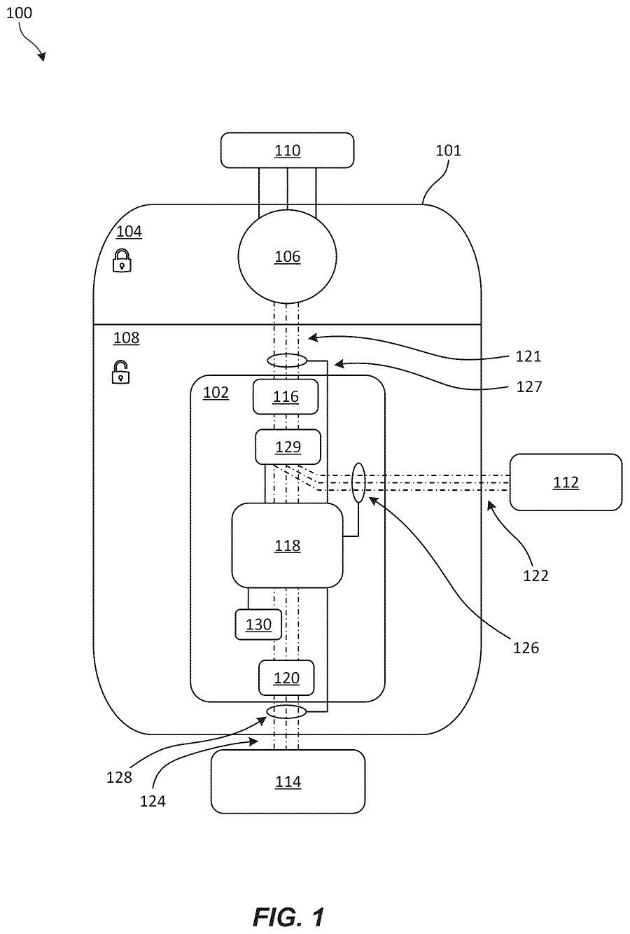

FIG. 1 is a schematic diagram of a power supply system 100 that includes an electrical power control device 102, according to at least one embodiment of the present disclosure. The power supply system 100 may be in the form of an expanded meter socket 101 that includes the electrical power control device 102.

For example, expanded meter socket 101 may be a multi-compartment meter socket 101 including a meter socket section 104 that houses a power meter 106 and a power control section 108 that houses the electrical power control device 102. In some embodiments, the meter socket section 104 may be locked or otherwise access-limited (e.g., for access only by personnel authorized by a power company), such as to inhibit tampering and/or theft of electrical power and for safety. The power control section 108 may be accessible by a user and/or electrician (e.g., without authorization by a power company), such as for installation, maintenance, modification, etc.

The power supply system 100 may be connected at an input side to a utility grid 110 for providing power to the power supply system 100, through the electrical power control device 102, and ultimately to a user's electrical systems, such as to a disconnect panel 112 (e.g., a residential breaker panel, a commercial breaker panel, a fuse box, a fusible switch box, a protective relay panel, etc.) and/or to an auxiliary device 114. In the example shown in FIG. 1, the utility grid 110 may provide a single-phase (e.g., three-wire) alternating current (AC) power supply including at least a hot wire and a neutral wire. In additional examples, the utility grid 110 may be a two-wire AC power supply or a four-wire AC power supply. The AC power supply from the utility grid 110 may be a single-phase (e.g., split-phase) AC power supply or a three-phase AC power supply.

Power from the utility grid 110 may pass through the power meter 106 for measuring total electrical power usage through the disconnect panel 112 and the auxiliary device 114. An output side of the power meter 106 may be operably connected to a power input of the electrical power control device 102, such as via suitable conductors (e.g., busbars, cables, wires, traces, etc.).

The electrical power control device 102 may include an input disconnect 116, a data collection and control module 118, and an auxiliary disconnect 120. An input power connection 121 may provide power to the electrical power control device 102, such as from the power meter 106 and ultimately from the utility grid 110. A main power connection 122 of the electrical power control device 102 may be capable of transmitting electrical power from the electrical power control device 102 to the disconnect panel 112. An auxiliary power connection 124 of the electrical power control device 102 may be capable of transmitting electrical power from the electrical power control device 102 to and/or from the auxiliary device 114.

The input disconnect 116 may be coupled to the input power connection 121 and positioned between the power meter 106 and the data collection and control module 118 and between the power meter 106 and the disconnect panel 112. In some embodiments, the input disconnect 116 may be rated with a sufficiently high amperage to supply full power to both the disconnect panel 112 and the auxiliary device 114. In other words, the current rating of the input disconnect 116 may be at least as high as the combination of the disconnect panel 112 rating and of the auxiliary device 114 rating, such as to reduce instances of the input disconnect 116 inadvertently opening and halting service to both the disconnect panel 112 and to the auxiliary device 114. In some embodiments, the input disconnect 116 may be rated the same as to the disconnect panel 112. In some use cases and situations, the input power may only be supplied to the disconnect panel 112 and no current may be distributed to the auxiliary device 114.

The auxiliary disconnect 120 may be along the auxiliary power connection 124 and positioned between the data collection and control module 118 and the auxiliary device 114. The auxiliary disconnect 120 may be configured to interrupt service to or from the auxiliary device 114 for installation or maintenance, in case of a fault (e.g., short-circuit) in the auxiliary device 114, for installation or maintenance of the data collection and control module 118, etc.

As will be explained further below, the data collection and control module 118 may be configured to sense a total electrical characteristic (e.g., current, voltage, etc.) of the input power connection 121, at least one first electrical characteristic (e.g., current, voltage, etc.) of the main power connection 122, and at least one second electrical characteristic (e.g., current, voltage, etc.) of the auxiliary power connection 124. For example, the electrical power control device 102 may include at least one input sensor 127 for sensing the total electrical characteristic (e.g., a total current) of the input power connection 121, at least one main sensor 126 for sensing the first electrical characteristic of the main power connection 122, and at least one auxiliary sensor 128 for sensing the second electrical characteristic of the auxiliary power connection 124. By way of example and not limitation, each of the at least one input sensor 127, at least one main sensor 126, and at least one auxiliary sensor 128 may be in the form of an inductive sensor, a current shunt sensor, a Hall effect-based sensor, a fluxgate sensor, and/or a Rogowski principle-based sensor (e.g., a Rogowski coil sensor).

The data collection and control module 118 may be in the form of a printed circuit board (PCB) that includes at least an analog-to-digital converter for processing signals from the at least one input sensor 127, at least one main sensor 126, and/or at least one auxiliary sensor 128 and a control module for controlling a flow of electrical current to at least the auxiliary device 114. In some examples, the data collection and control module 118 may also include a communication module for communicating information based on the signals to a user device or other recipient. One or more of these components of the data collection and control module 118 may be implemented via one or more microcontrollers, signal processing components, transistors, transceivers, etc.

In some examples, relational terms, such as “first,” “second,” etc., may be used for clarity and convenience in understanding the disclosure and accompanying drawings and do not connote or depend on any specific preference, orientation, or order, except where the context clearly indicates otherwise.

In some embodiments, the first electrical characteristic and the second electrical characteristic may include current and/or voltage, and/or a characteristic derived from current and/or voltage (e.g., power). The data collection and control module 118 may also be configured to communicate the first and second electrical characteristic, or information based on the first and second electrical characteristic, to a user device or other recipient. For example, the input sensor 127 may be or include an input current sensor for sensing an electrical current in the input power connection 121, the main sensor 126 may be or include a first current sensor for sensing an electrical current in the main power connection 122, and the auxiliary sensor 128 may be or include a second current sensor for sensing an electrical current in the auxiliary power connection 124.

The auxiliary device 114 may be one or more devices that can use electrical power, functioning as a current load. Examples of the auxiliary device 114 include an electric vehicle (EV) charging station, an electric vehicle, a pump, an air conditioning unit, a heater, a refrigerator, etc. Other devices that draw electrical power and that are not typically fed electricity through the disconnect panel 112 may also be considered auxiliary devices 114.

In additional embodiments of the present disclosure, the auxiliary device 114 may generate electricity, functioning as a current source. In this case, the auxiliary device 114 may provide electrical power to the disconnect panel 112 (and ultimately to electronic devices connected to the disconnect panel) and/or back to the utility grid 110 where allowed by local regulations. For example, the auxiliary device 114 may be or include a wind turbine, a water turbine, a thermal power generator, a gas generator, a solar panel, etc.

In further embodiments, the auxiliary device 114 may be a hybrid device that can act as a current load during some periods and as a current source during other periods. For example, a hybrid auxiliary device 114 may be an EV charging station connected to an electric vehicle, or an EV itself. In this example, the EV charging station or EV may draw current from the utility grid 110 when charging. When there is a utility outage or during periods of peak demand, a battery onboard the EV and/or a storage battery of the EV charging station may provide current back through the power supply system 100, such as to the disconnect panel 112 for use by appliances connected to the disconnect panel 112. Similarly, an energy storage device, such as a battery, may act as a current load for charging purposes and may act as a current source when discharging to provide electricity to the disconnect panel 112. Likewise, a backup generator, such as a mobile or standby backup generator, may function as a current load when not in power generation mode and may function as a current source when in power generation mode.

In some embodiments, an EV may include sufficient onboard circuitry and components to charge and/or discharge by connecting to a standard (e.g., 110V, 115V, 120V, 208V, 220V, 230V, 240V, etc.) electrical outlet without a separate EV charging station. Examples of such EVs may function as a current load or as a current source.

The at least one auxiliary sensor 128 can, in some embodiments, be used to obtain electrical characteristic data regardless of the direction that electrical current flows in the auxiliary power connection 124.

In some embodiments, the electrical power control device 102 may include a main relay 129 operably coupled to at least a portion of the input power connection 121 and an auxiliary relay 130 operably coupled to the auxiliary power connection 124. The main relay 129 may be configured to open to stop flow and/or close to allow flow of at least some electrical current through the input power connection 121. For example, the main relay 129 may be configured to be closed during normal operation to provide electrical power to the disconnect panel 112 and/or to the auxiliary device 114. In some embodiments, the main relay 129 may be configured to be opened when the utility grid 110 has an outage and the auxiliary device 114 acts as a backup source to provide power to the disconnect panel 112.

Similarly, the auxiliary relay 130 may be configured to open to stop flow and/or close to allow flow of at least some electrical current through the auxiliary power connection 124. For example, the auxiliary relay 130 may be configured to open in response to the data collection and control module 118 determining that a total current through the input power connection 121, or through the main power connection 122 and through the auxiliary power connection 124, meets or exceeds a predetermined safety threshold (e.g., a threshold between 50 percent and 95 percent of a maximum ampacity rating of the input disconnect 116, between 70 percent and 95 percent of the maximum ampacity rating, such as 80 percent of the maximum ampacity rating). The auxiliary relay 130 may also be configured to close in response to the data collection and control module 118 determining that the total current through the input power connection 121 or through the main power connection 122 and through the auxiliary power connection 124 meets or falls below a predetermined reconnection threshold (e.g., equal to or less than the predetermined safety threshold, such as between 40 percent and 90 percent of the maximum ampacity rating of the input disconnect 116). In embodiments in which the auxiliary device 114 can function as a source, the auxiliary relay 130 may be configured to open during normal operation to allow the utility grid 110 to supply power to the disconnect panel 112 and to close during an outage of the utility grid 110 to supply backup power from the auxiliary device 114 to the disconnect panel 112.

Accordingly, in some examples in which the auxiliary device 114 is or can function as a source of electrical power, the power supply system 100 may enable automatic switching between the utility grid 110 and the auxiliary device 114 as a source of power for the disconnect panel 112. In some embodiments, this automatic switching may be accomplished without the use of, and at a lower cost than, an automatic transfer switch.

FIG. 1 illustrates a single auxiliary device 114. However, the present disclosure is not so limited. In additional examples, the auxiliary device 114 may represent multiple auxiliary devices 114 connected to the electrical power control device 102. In embodiments in which multiple auxiliary devices 114 are used, a single auxiliary relay 130 may be used to stop at least some electrical current flow to all auxiliary devices 114 when the predetermined safety threshold is met or exceeded, or a respective auxiliary relay 130 may be employed for each of the auxiliary devices 114 to selectively stop at least some electrical current flow to one or more of the multiple auxiliary devices 114.

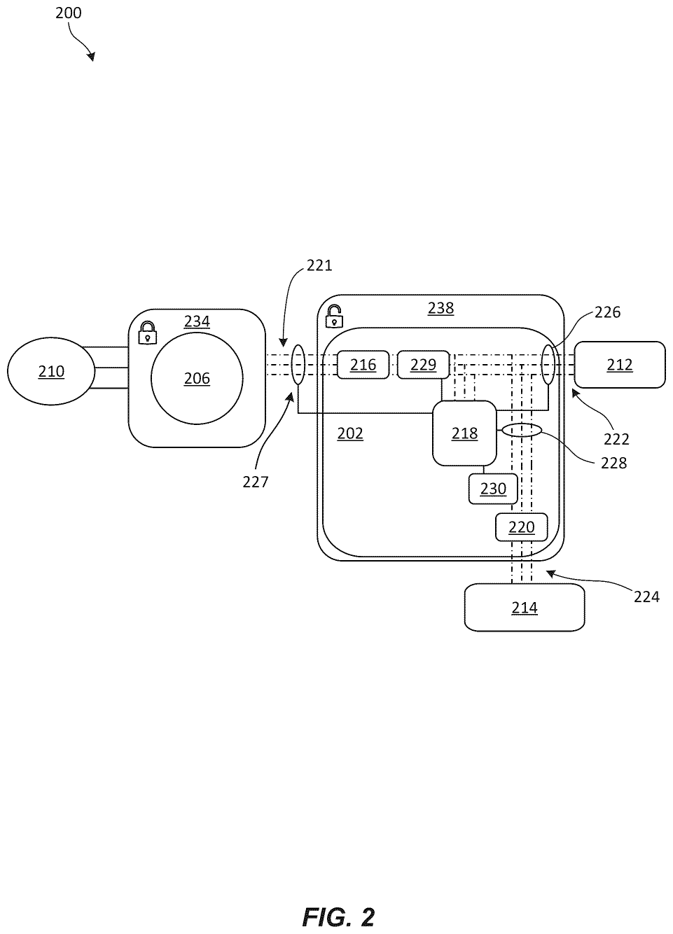

FIG. 2 is a schematic diagram of a power supply system 200 that includes an electrical power control device 202, according to at least one additional embodiment of the present disclosure.

In some respects, the power supply system 200 of FIG. 2 may be similar to the power supply system 100 illustrated in FIG. 1. For example, the power supply system 200 of FIG. 2 may include a power meter 206 that receives electrical power from a utility grid 210, a disconnect panel 212, an auxiliary device 214, and the electrical power control device 202 that is configured to monitor electrical characteristics of an input power connection 221, a main power connection 222 to the disconnect panel 212, and an auxiliary power connection 224 to the auxiliary device 214, such as via a respective input sensor 227, main sensor 226, and/or an auxiliary sensor 228. The electrical power control device 202 may include an input disconnect 216 coupled to the input power connection 221, a data collection and control module 218, and an auxiliary disconnect 220 coupled to the auxiliary power connection 224. The electrical power control device 202 may also include a main relay 229 configured to open to stop flow of at least some electrical current through the input power connection 221 or close to allow current flow through the input power connection 221. The electrical power control device 202 may include an auxiliary relay 230 configured to open to stop flow of at least some electrical current through the auxiliary power connection 224, such as when a predetermined safety threshold is met or exceeded, or close to allow current flow through the auxiliary power connection 224. The main relay 229 and auxiliary relay 230 may also be selectively operated to control the flow of electricity in various situations, such as when the auxiliary device 214 is configured to act as a power source.

Referring to FIG. 2, the power supply system 200 may include a meter socket 234 containing the power meter 206 that is external to (e.g., physically separate from) a housing 238 that contains the electrical power control device 202. In some examples, the housing 238 and electrical power control device 202 therein may be mounted adjacent to (e.g., along a same wall as) the meter socket 234. In additional examples, the housing 238 and electrical power control device 202 may be mounted remotely from the meter socket 234, such as adjacent to the auxiliary device 214 or adjacent to the disconnect panel 212.

Accordingly, referring to FIGS. 1 and 2, electrical power control devices 102, 202 of the present disclosure may be implemented as part of an expanded meter socket 101 or via a housing 238 that is separate from a meter socket 234. The functional components of the electrical power control devices 102, 202 may be the same or similar in either case.

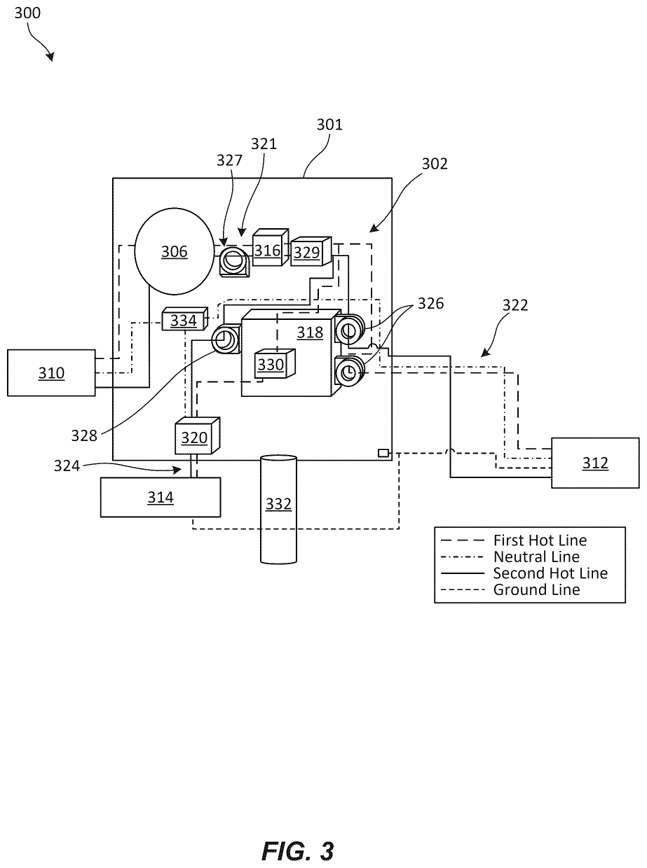

FIG. 3 is a schematic diagram of a power supply system 300 that includes an electrical power control device 302, according to at least one further embodiment of the present disclosure.

In some respects, the power supply system 300 of FIG. 3 may be similar to the power supply system 100 illustrated in FIG. 1. For example, the power supply system 300 of FIG. 3 may include a power meter 306 that receives electrical power from a utility grid 310, a disconnect panel 312, an auxiliary device 314, and the electrical power control device 302 that is configured to monitor electrical characteristics of an input power connection 321, a main power connection 322 to the disconnect panel 312 and an auxiliary power connection 324 to the auxiliary device 314, such as via an input sensor 327, one or more main sensors 326, and/or an auxiliary sensor 328. The power supply system 300 may be implemented in the form of an expanded meter socket 301. The electrical power control device 302 may include an input disconnect 316 coupled to the input power connection 321, a data collection and control module 318, and an auxiliary disconnect 320 coupled to the auxiliary power connection 324. The electrical power control device 302 may include a main relay 329 configured to open to stop flow of at least some electrical current through the input power connection 321 or close to allow current flow through the input power connection 321. The electrical power control device 302 may include an auxiliary relay 330 configured to open to stop flow of at least some electrical current through the auxiliary power connection 324 (e.g., to stop flow of the electrical current through at least one hot wire of the auxiliary power connection 324) when a predetermined safety threshold is met or exceeded. The auxiliary relay 330 may also be configured to close to allow flow of at least some electrical current through the auxiliary power connection 324 when a predetermined reconnection threshold is met. The main relay 329 and auxiliary relay 330 may also be selectively operated to control the flow of electricity in various situations, such as when the auxiliary device 314 is configured to act as a power source.

In FIG. 3, the power supply system 300 is illustrated as a split-phase alternating-current (AC) system. Long dashed connector lines represent a first hot line, dash-dot lines represent a neutral line, solid lines represent a second hot line, and short dashed lines represent a ground line. Components of the power supply system 300 may be operably coupled to one, two, three, or four of these lines, such as depending on their electrical operating characteristics (e.g., designed operating voltage, current, phase, grounding requirements, etc.). The ground line may be electrically coupled to a ground rod 332 or other grounded conductive element, which may in turn be electrically coupled to a housing (e.g., a metal box) of the expanded meter socket 301. The neutral line may be electrically coupled to a neutral lug 334 positioned in the expanded meter socket 301.

In various embodiments of the present disclosure, the power supply system 300 may be a single-phase power system, a split-phase power system, a three-phase power system, a hybrid system, etc.

For example, the data collection and control module 318 may collect and monitor data from the input sensor 327 indicative of a total electrical current passing through the input power connection 321, from the one or more main sensors 326 indicative of a first electrical current passing through the main power connection 322 to the disconnect panel 312, and from the auxiliary sensor 328 indicative of a second electrical current passing through the auxiliary power connection 324 to the auxiliary device 314. Based on this data, the data collection and control module 318 may cause the auxiliary relay 330 to open or close to respectively stop or allow the flow of electrical current through one or more hot wires of the auxiliary power connection 324. As illustrated in FIG. 3, the auxiliary relay 330 may, in some embodiments, be operably coupled to one of two hot wires of the auxiliary power connection 324. In additional examples, a single relay or two respective relays may be operably coupled to two hot wires of the auxiliary power connection 324.

For example, if the combination of the first electrical current and the second electrical current reaches a predetermined safety threshold, the data collection and control module 318 may cause the auxiliary relay 330 to open to stop flow of at least some of the electrical current passing through the auxiliary power connection 324. By way of example and not limitation, the predetermined safety threshold may be between 50 percent and 95 percent of a maximum ampacity rating of the input disconnect 316, such as between 70 percent and 95 percent of the maximum ampacity rating, such as about 80 percent of the maximum ampacity rating. For example, the maximum ampacity rating may be in a range of 20 amps to 400 amps, although other maximum ampacity ratings may be possible in additional situations.

After the auxiliary relay 330 is opened, reconnection may occur when the total current or the combination of the first electrical current and the second electrical current reaches a predetermined reconnection threshold. The predetermined reconnection threshold may be lower than the predetermined safety threshold. For example, the predetermined reconnection threshold may be between about 40 percent and about 90 percent of the maximum ampacity rating of the input disconnect 316, such as about 70 percent of the maximum ampacity rating when the predetermined safety threshold is 80 percent of the maximum ampacity rating. In additional examples, the predetermined reconnection threshold may be 75 percent and the predetermined safety threshold may be 80 percent of the maximum ampacity rating.

In the example shown in FIG. 3, two main sensors 326 are illustrated for measuring an electrical current through the respective first hot line and second hot line. While the electrical current level through the first hot line may be similar to the electrical current through the second hot line, these current levels may not always be identical at any specific time. For determining whether the predetermined safety threshold and/or the predetermined reconnection threshold is met, the data collection and control module 318 may use a highest value for the two main sensors 326 for increased safety.

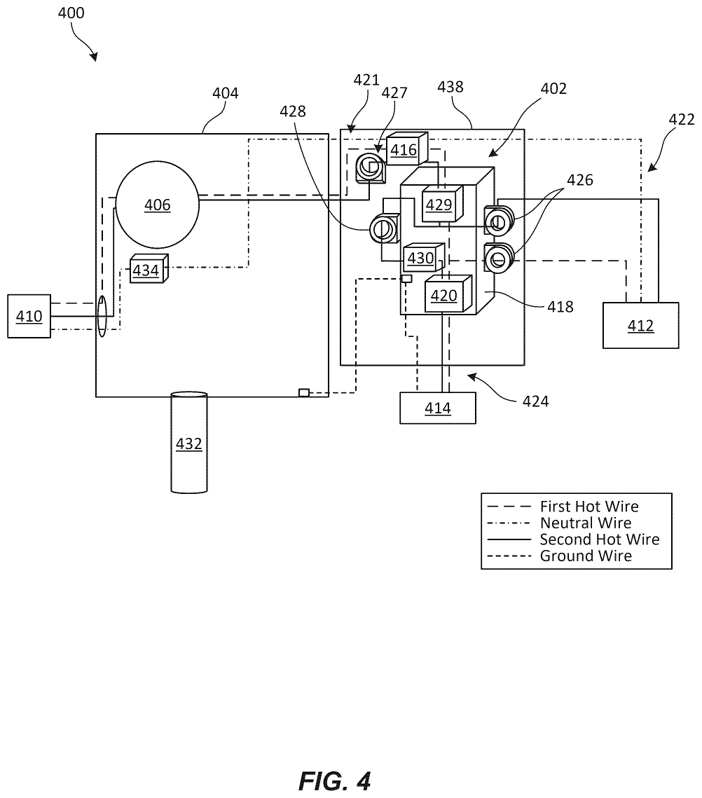

FIG. 4 is a schematic diagram of a power supply system 400 that includes an electrical power control device 402, according to at least one additional embodiment of the present disclosure.

In some respects, the power supply system 400 of FIG. 4 may be similar to the power supply system 200 illustrated in FIG. 2. For example, the power supply system 400 of FIG. 4 may include a power meter 406 that receives electrical power from a utility grid 410, a disconnect panel 412, an auxiliary device 414, and the electrical power control device 402 that is configured to monitor electrical characteristics of an input connection 421, a main power connection 422 to the disconnect panel 412, and an auxiliary power connection 424 to the auxiliary device 414, such as via an input sensor 427, one or more main sensors 426, and/or an auxiliary sensor 428. The electrical power control device 402 may be contained in a housing 438 that is separate from a meter socket 404 that contains the power meter 406.

The electrical power control device 402 may include an input disconnect 416 coupled to the input power connection 421, a data collection and control module 418, and an auxiliary disconnect 420 coupled to the auxiliary power connection 224. The electrical power control device 402 may include a main relay 429 configured to open to stop flow of at least some electrical current through the input power connection 421 or close to allow current flow through the input power connection 421. The electrical power control device 402 may include an auxiliary relay 430 configured to open to stop flow of at least some electrical current through the auxiliary power connection 424 when a predetermined safety threshold is met or exceeded. The auxiliary relay 430 may also be configured to close to allow flow of at least some electrical current through the auxiliary power connection 424 when a predetermined reconnection threshold is met. The main relay 429 and auxiliary relay 430 may also be selectively operated to control the flow of electricity in various situations, such as when the auxiliary device 414 is configured to act as a power source.

A ground rod 432 or other grounded conductive element may be electrically coupled to a housing of the meter socket 404 and/or to the housing 438 that contains the electrical power control device 402.

The data collection and control module 418 may collect and monitor data from the input sensor 127 indicative of a total electrical current passing through the input power connection 421, from the one or more main sensors 426 indicative of a first electrical current passing through the main power connection 422 to the disconnect panel 412, and from the auxiliary sensor 428 indicative of a second electrical current passing through the auxiliary power connection 424 to the auxiliary device 414. Based on this data, the data collection and control module 418 may cause the auxiliary relay 430 to open or close to respectively stop or allow the flow of electrical current through one or more hot wires of the auxiliary power connection 424. For example, the data collection and control module 418 may cause the auxiliary relay 430 to respectively open and close when the total electrical current passing through the main power connection 422 and auxiliary power connection 424 reaches the predetermined safety threshold and the predetermined reconnection threshold.

In some embodiments, the electrical power control device 402 may include a PCB to which the auxiliary disconnect 420, the input sensor 427, the one or more main sensors 426, the auxiliary sensor 428, the main relay 429, and the auxiliary relay 430 may be mounted. In additional embodiments, the input disconnect 416 may also be mounted to the PCB of the electrical power control device 402. In other embodiments, one or more of these components may be mounted to the housing 438 separate from the PCB of the electrical power control device 402. Accordingly, in some examples, the electrical power control device 402 may be an integrated package that can be electrically coupled to the meter socket 404, disconnect panel 412, and auxiliary device 414.

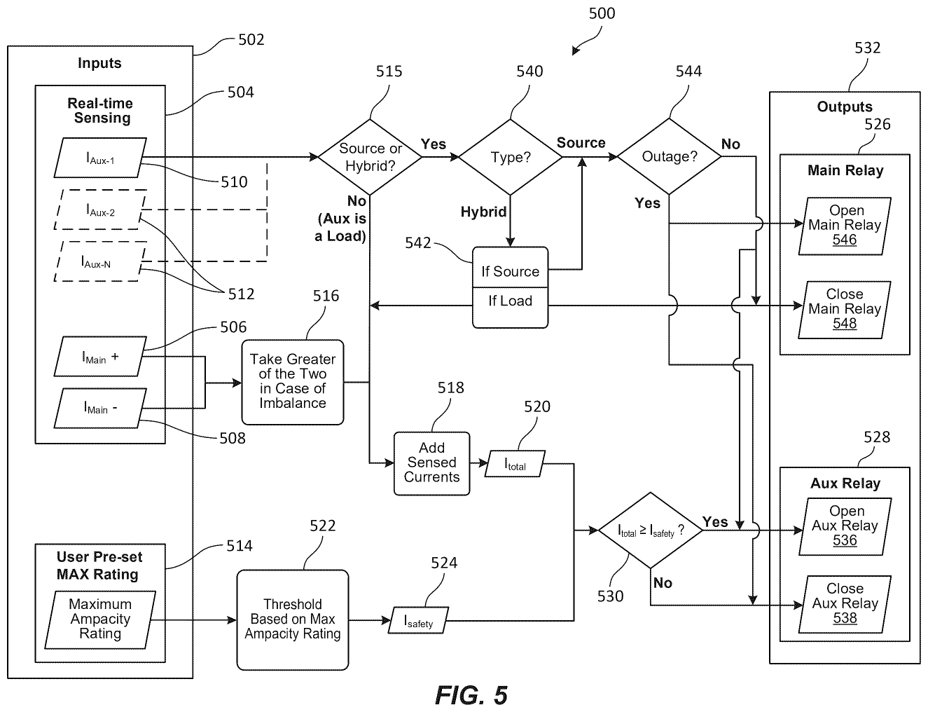

FIG. 5 is a flow diagram illustrating a method 500 of operating an electrical power control device, according to at least one embodiment of the present disclosure. The method 500 may be implemented by a power supply system, such as any of the power supply systems 100, 200, 300, 400 described above.

A lower portion of FIG. 5 represents a process that may be performed when an auxiliary device is a load or is functioning as a load. An upper portion of FIG. 5 represents a process that may be performed with an auxiliary device is a source or is functioning as a source.

At operation 502, various inputs may be received by the power supply system. For example, real-time sensing 504 of an input current (e.g., through an input power connection), a first main current 506 (e.g., through a first hot wire of a main power connection), second main current 508 (e.g., through a second hot wire of the main power connection), and auxiliary current 510 (e.g., through a hot wire of an auxiliary power connection) may be performed, such as by respective electrical current sensors. Optionally, if more than one auxiliary device is present, real-time sensing 504 of one or more additional auxiliary currents 512 may also be performed.

A user pre-set maximum rating 514 may also be an input received by the power supply system. The maximum rating 514 may be based on a maximum ampacity rating of an input disconnect or meter socket through which electrical power is provided to a house or commercial establishment. For example, the maximum ampacity rating may be determined based on indications from a manufacturer of the input disconnect or meter socket. For example, the maximum ampacity rating may be in a range of 20 amps to 400 amps, such as 20 amps, 80 amps, 100 amps, 160 amps, 200 amps, 320 amps, or 400 amps. The maximum ampacity rating may be set by a user or technician during installation of the power supply system or at a later time, such as via toggling a physical switch or by entering the maximum ampacity rating via a software interface.

At query 515, the system may determine whether the auxiliary device (and any additional auxiliary device) is a source or a hybrid device such that it is capable of generating electricity. For example, the system may answer query 515 by receiving a setting or other indication from a user or technician that the auxiliary device is a source or a hybrid device. The setting or indication may be provided as a state of a physical toggle switch, slider switch, knob, jumper, etc., or as a software setting. In other examples, the system may answer query 515 by communicating with the auxiliary device via a wired or a wireless communication link. If the auxiliary device is not a source or a hybrid device, the system may assume that the auxiliary device is a load.

Assuming the auxiliary device is a load or is functioning as a load, then the system may ensure that the power supply is operating at or below a maximum ampacity rating, such as to avoid inadvertent tripping of a disconnect.

At operation 516, the first main current 506 and the second main current 508 may be compared to determine which is greater in case there is an imbalance between the two. The greater of the two currents may be used in calculating a total current 520 for increased safety in the power supply system.

At operation 518, the greater main current 506 or 508 may be added to the auxiliary current 510 (and any additional auxiliary currents 512, if applicable) to obtain the total current 520 passing through the power supply system. Additionally or alternatively, the total current 520 may be obtained from an input sensor coupled to an input power connection.

At operation 522, a threshold based on the maximum ampacity rating 514 may be determined. For example, a predetermined safety threshold 524 may be between 50 percent and 95 percent of the maximum ampacity rating 514, such as between 70 percent and 95 percent of the maximum ampacity rating 514, such as about 80 percent of the maximum ampacity rating 514. The percentage of the predetermined safety threshold 524 may be selected by a user or may be pre-set.

At query 530, the total current 520 may be compared to the predetermined safety threshold 524. For example, the system may determine whether the total current 520 is greater than or equal to the predetermined safety threshold 524.

Outputs 532 may include the opening (or maintaining open) or closing (or maintaining closed) of a main relay 526 and of an auxiliary relay 528. Assuming the auxiliary device (and additional auxiliary devices, if present) is functioning as a load, the opening or closing of the auxiliary relay 528 may depend on answers to the query 530. For example, if the answer to query 530 is yes and the total current 520 reaches or exceeds the predetermined safety threshold 524, then the auxiliary relay 528 may be opened 536 or maintained open to stop the flow of electrical current to the auxiliary device. If the answer to query 530 is no and the total current 520 is below the predetermined safety threshold 524, then the auxiliary relay 528 may be closed 538 or maintained closed.

The result of query 530 may enable the power supply system to prioritize providing power to a main electrical connection, such as to a main disconnect panel (e.g., residential breaker panel, a commercial breaker panel, etc.), over providing power to an auxiliary device (such as an EV charging station, etc.). This result may also reduce a risk of a disconnect tripping and interrupting service to the main disconnect panel, an electronic device or appliance connected to the main disconnect panel, and/or to the auxiliary device. Such tripping of a disconnect may otherwise require manually resetting to restore power, which can be a nuisance to a user.

Returning to query 515, if the auxiliary device is a source or a hybrid device, then the system may further determine whether the auxiliary device is a source device or a hybrid device at query 540. If the auxiliary device is a hybrid device, then the system may further determine whether the hybrid device is presently functioning as a source or a load at operation 542. In some examples, this determination may be made by receiving a setting or indication from a user or technician or by communicating with the auxiliary device via a wired or wireless communication link. If the hybrid device is presently functioning as a load, then the process discussed above of adding the auxiliary current 510 (and any additional auxiliary currents 512) to the greater of the main currents 506, 508 at operation 518 and comparing the total current 520 to the predetermined safety threshold 524 at query 530 may be performed.

On the other hand, if in response to query 540 and/or operation 542 the system determines that the auxiliary device is a source or is presently functioning as a source, the system may monitor whether there is an outage (e.g., at a utility grid providing power to the system) at query 544. If the system detects that there is no outage or that the outage is resolved, then the main relay 526 that connects the utility grid to the system loads may be closed 548 or may remain closed to provide power as usual. At the same time, the system may open 536 the auxiliary relay 528 to keep the auxiliary relay 528 from supplying power to the system loads and/or back to the utility grid.

In some localities, a user supplying power to the utility grid may be forbidden or restricted. Accordingly, a default setup may dictate that if the main relay 526 is closed 548, then the auxiliary relay 528 should normally remain open 536 to avoid back-feeding power to the utility grid as described above.

In localities where regulations allow back-feeding of power to the utility grid, the system may receive that information at setup or in real-time or periodically (e.g., through communication with a user device, with a utility provider, etc.). In response, the system may function differently than has been described above. For example, if the system determines at query 515, query 540, and/or operation 542 that the auxiliary device is functioning as a source, no outage is detected at query 544, and the system is allowed to back-feed power to the utility grid, then the system may be set to close 548 the main relay 526 and also close 538 the auxiliary relay 528 at the same time. This state may enable power from the auxiliary device to flow through the auxiliary relay 528 and main relay 526 and back to the utility grid.

Returning to query 544, if the system determines that there is an outage (e.g., at the utility grid), then the system may open 546 or maintain opened the main relay 526 and close 538 or maintain closed the auxiliary relay 528. In this state, the auxiliary device may be able to act as a source to provide power to system loads in the absence of power from the utility grid. The opening 546 of the main relay may prevent power from back-feeding into the utility grid. The auxiliary device, therefore, may act as a backup source of power in the event of an outage at the utility grid.

The outputs 532 may be performed automatically in response to the system performing the real-time sensing 504 of the electrical currents, comparing those to the predetermined safety threshold, determining whether the auxiliary device functions as a source, and identifying any outage in the utility grid, as outlined above. By automatically opening and closing the auxiliary relay and the main relay to manage the flow of electrical current, interruptions may be reduced even during periods of high electrical demand or outages. In addition, the chance of disconnects (e.g., breakers and/or fuses) tripping may be considerably less, which may also reduce the need for a consumer to manually correct those interruptions. At the same time, safety may be maintained and local regulations relating to back-feeding may be honored by such systems.

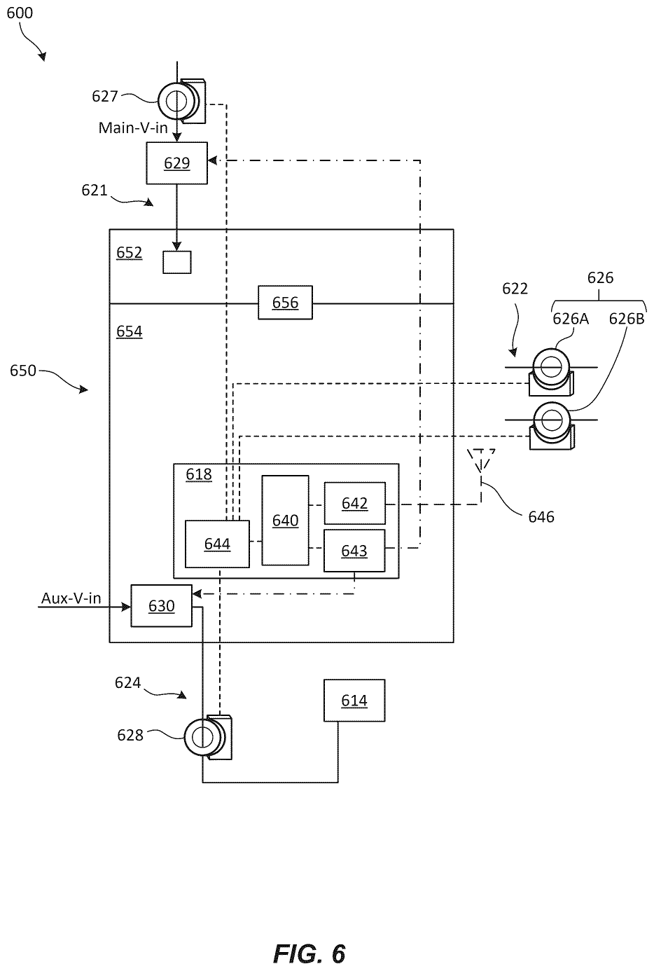

FIG. 6 is a schematic diagram of an electrical power control device 600, according to at least one embodiment of the present disclosure. In some examples, the electrical power control device 600 may be implemented or employed as any of the electrical power control devices 102, 202, 302, 402 described above.

The electrical power control device 600 may include a data collection and control module 618, which may be implemented in one or more microcontrollers and/or separate modules. The data collection and control module 618 may include a data collection module 640, a communication module 642, and a relay control module 643.

The data collection module 640 may receive data from an input sensor 627 coupled to an input power connection 621. The data collection module 640 may also receive data from at least one main sensor 626 (e.g., a first main sensor 626A and a second main sensor 626B) coupled to a main power connection 622. In the example illustrated in FIG. 6, the main power connection 622 may be configured for split-phase power. The first main sensor 626A may be coupled to a hot wire associated with a first AC phase and the second main sensor 626B may be coupled to a hot wire associated with a second AC phase. In additional embodiments, a single main sensor 626 or more than two main sensors 626 may be employed. The first main sensor 626A and the second main sensor 626B may be configured to sense one or more electrical characteristics (e.g., current, voltage) of the main power connection 622.

The data collection module 640 may also receive data from at least one auxiliary sensor 628. Only one auxiliary sensor 628 is illustrated in FIG. 6. However, the present disclosure is not so limited. In additional embodiments, multiple auxiliary sensors 628 may be used. The at least one auxiliary sensor 628 may be coupled to an auxiliary power connection 624, such as a hot wire of the auxiliary power connection 624, connected to an auxiliary device 614. The at least one auxiliary sensor 628 may be configured to sense at least one electrical characteristic (e.g., current, voltage) of the auxiliary power connection 624.

The data collection and control module 618 may also include an analog-to-digital converter 644 for converting analog signals from the input sensor 627, from the at least one main sensor 626, and from the at least one auxiliary sensor 628 to digital signals. The data collection module 640 may receive the digital signals from the analog-to-digital converter 644 and may pass information based on the digital signals to the communication module 642 for communication to a user device, such as via a wired connection or a wireless connection (e.g., via an antenna 646). The data collection module 640 may also pass information based on the digital signals to the relay control module 643, which may control operation (e.g., opening and closing) of the main relay 629 coupled to the input power connection 621 and an auxiliary relay 630 coupled to the auxiliary power connection 624.

In some examples of the present disclosure, the electrical power control device 600 may include one or more printed circuit boards (PCBs). For example, as illustrated in FIG. 6, a main PCB 650 may support the data collection and control module 618. The main PCB 650 may include a high-voltage power plane 652 (e.g., a 240 VAC power plane) and a low-voltage power plane 654 (e.g., a 5 V power plane, a 3.3 V power plane, etc.). The main PCB 650 may also include a ground plane. The high-voltage power plane 652 may be operably coupled to the low-voltage power plane 654 by a step-down transformer 656, which may convert high voltage from the high-voltage power plane 652 to low voltage to supply the low-voltage power plane 654.

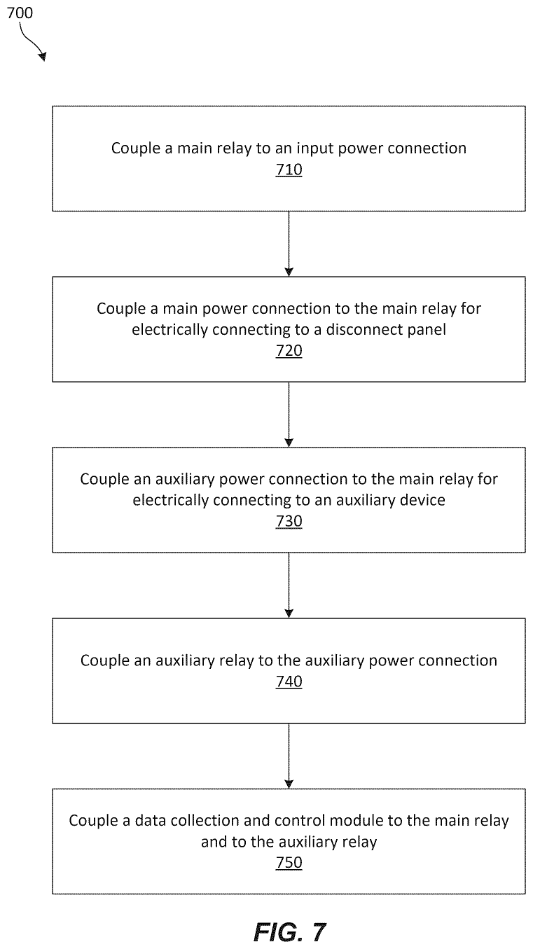

FIG. 7 is a flow diagram illustrating a method 700 of forming an electrical power control device, according to at least one embodiment of the present disclosure.

At operation 710, a main relay may be coupled to an input power connection.

At operation 720, a main power connection may be coupled to the main relay for electrically connecting to a disconnect panel. In some examples, a main current sensor may be coupled to the main power connection to sense a main electrical current flowing through the main power connection.

At operation 730, an auxiliary power connection may be coupled to the main relay for electrically connecting to an auxiliary device. In some examples, an auxiliary current sensor may be coupled to the auxiliar power connection to sense an auxiliary electrical current flowing through the auxiliary power connection.

At operation 740, an auxiliary relay may be coupled to the auxiliary power connection.

At operation 750, a data collection and control module may be coupled to the main relay and to the auxiliary relay such that the data collection and control module is configured to selectively open and close the main relay and to selectively open and close the auxiliary relay depending on whether the auxiliary device functions as a current load or a current source. In some examples, the data collection and control module may also be coupled to an input current sensor and/or the main current sensor such that the data collection and control module can receive data from the input current sensor and/or main current sensor. In some embodiments, the data collection and control module may be coupled to the auxiliary current sensor such that the data collection and control module can receive data from the auxiliary current sensor.

In some examples, the term “about” in reference to a given parameter, property, or condition, may refer to a degree that one skilled in the art would understand that the given parameter, property, or condition is met with a small degree of variance, such as within acceptable manufacturing tolerances and/or conventional measurement techniques. For example, a parameter that is “about” met may be at least about 90% met, at least about 95% met, at least about 99% met, or fully met.

Accordingly, the present disclosure includes devices, systems, and methods that may be useful for managing electrical power usage in systems that include a main power branch (e.g., to a disconnect panel) and one or more auxiliary power branches (e.g., to one or more auxiliary devices). These concepts may be employed to automatically shut off or reconnect power to one or more auxiliary devices when electrical current thresholds are met to reduce the chance of disconnects tripping during periods of high electricity usage.

The following example embodiments are also included in the present disclosure.

Example 1. An electrical power control device, including: a main relay coupled to an input power connection; a main power connection for transmitting electrical power from the main relay to a disconnect panel; an auxiliary power connection for transmitting electrical power from the main relay to an auxiliary device that can function as a current load or a current source; an auxiliary relay coupled to the auxiliary power connection; and a data collection and control module coupled to the main relay and the auxiliary relay, wherein the data collection and control module is configured to selectively open and close the main relay and to selectively open and close the auxiliary relay depending on whether the auxiliary device functions as a current load or a current source.

Example 2. The device of Example 1, wherein the data collection and control module is further configured to open or maintain open the main relay and close or maintain closed the auxiliary relay when the auxiliary device functions as a current source.

Example 3. The device of Example 1 or Example 2, wherein the data collection and control module is further configured to close or maintain closed the main relay and close or maintain closed the auxiliary relay when the auxiliary device functions as a current load.

Example 4. The device of any one of Examples 1 through 3, further including an input disconnect coupled to the input power connection.

Example 5. The device of any one of Examples 1 through 4, further including an auxiliary disconnect coupled to the auxiliary power connection.

Example 6. The device of any one of Examples 1 through 5, wherein the auxiliary device includes at least one of: an electric vehicle charging station; an electric vehicle; a battery; or a generator.

Example 7. The device of any one of Examples 1 through 6, wherein: the auxiliary power connection includes one or more hot lines; and the auxiliary relay is coupled to a hot line of the one or more hot lines of the auxiliary power connection.

Example 8. The device of any one of Examples 1 through 7, wherein the data collection and control module is further configured to close or maintained closed the auxiliary relay and open or maintain open the main relay when an outage from the input power connection occurs and power to the input power connection is halted.

Example 9. The device of Example 8, wherein the data collection and control module is further configured open the auxiliary relay and close the main relay when the outage is resolved and power to the input power connection is restored.

Example 10. The device of any one of Examples 1 through 9, further including a housing containing the main relay, auxiliary relay, and data collection and control module.

Example 11. The device of Example 10, wherein the housing is separate from a meter socket.

Example 12. The device of Example 10, wherein the housing further contains a power meter.

Example 13. An electrical power control device, including: a main relay coupled to an input power connection; a main power connection for transmitting electrical power from the main relay to a disconnect panel; an auxiliary power connection for transmitting electrical power from the main relay to an auxiliary device; an auxiliary relay coupled to the auxiliary power connection; an input current sensor configured to sense an input electrical current flowing through the input power connection; a main current sensor configured to sense a main electrical current flowing through the main power connection; an auxiliary current sensor configured to sense a second electrical current flowing through the auxiliary power connection; and a data collection and control module coupled to the main relay, the auxiliary relay, the input current sensor, the main current sensor, and the auxiliary current sensor, wherein the data collection and control module is configured to selectively open and close the main relay and to selectively open and close the auxiliary relay depending on whether the auxiliary device functions as a current load or a current source.

Example 14. The device of Example 13, wherein the data collection and control module is further configured to open the auxiliary relay when a total current flowing through at least one of the input power connection, the main power connection, or the auxiliary power connection reaches or exceeds a predetermined safety threshold.

Example 15. The device of Example 14, wherein the predetermined safety threshold is between 50 percent and 95 percent of a maximum ampacity rating of the input disconnect.

Example 16. The device of Example 14 or Example 15, wherein the predetermined safety threshold is between 70 percent and 95 percent of a maximum ampacity rating of the input disconnect.

Example 17. The device of any one of Examples 13 through 16, wherein the data collection and control module further includes a communication module configured to send information based on data from the input current sensor, the main current sensor, and the auxiliary current sensor to a user device.

Example 18. A method of forming an electrical power control device, the method including: coupling a main relay to an input power connection; coupling a main power connection to the main relay for electrically connecting to a disconnect panel; coupling an auxiliary power connection to the main relay for electrically connecting to an auxiliary device; coupling an auxiliary relay to the auxiliary power connection; and coupling a data collection and control module to the main relay and to the auxiliary relay such that the data collection and control module is configured to selectively open and close the main relay and to selectively open and close the auxiliary relay depending on whether the auxiliary device functions as a current load or a current source.

Example 19. The method of Example 18, further including: coupling an input current sensor to the input power connection to sense an input electrical current flowing through the input power connection; coupling a main current sensor to the main power connection to sense a main electrical current flowing through the main power connection; and coupling the data collection and control module to the input current sensor and the main current sensor such that the data collection and control module can receive data from the input current sensor and the main current sensor.

Example 20. The method of Example 18 or Example 19, further including: coupling an auxiliary current sensor to the auxiliary power connection to sense an auxiliary electrical current flowing through the auxiliary power connection; and coupling the data collection and control module to the auxiliary current sensor such that the data collection and control module can receive data from the auxiliary current sensor.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An electrical power control device, comprising:
a main relay coupled to an input power connection;
a main power connection for transmitting electrical power from the main relay to a disconnect panel;
an auxiliary power connection for transmitting electrical power from the main relay to an auxiliary device that can function as a current load or a current source;
an auxiliary relay coupled to the auxiliary power connection; and
a data collection and control module coupled to the main relay and the auxiliary relay, wherein the data collection and control module is configured to selectively open and close the main relay and to selectively open and close the auxiliary relay depending on whether the auxiliary device functions as a current load or a current source.

2. The device of claim 1, wherein the data collection and control module is further configured to open or maintain open the main relay and close or maintain closed the auxiliary relay when the auxiliary device functions as a current source.

3. The device of claim 1, wherein the data collection and control module is further configured to close or maintain closed the main relay and close or maintain closed the auxiliary relay when the auxiliary device functions as a current load.

4. The device of claim 1, further comprising an input disconnect coupled to the input power connection.

5. The device of claim 1, further comprising an auxiliary disconnect coupled to the auxiliary power connection.

6. The device of claim 1, wherein the auxiliary device comprises at least one of:
an electric vehicle charging station;
an electric vehicle;
a battery; or
a generator.

7. The device of claim 1, wherein:
the auxiliary power connection comprises one or more hot lines; and
the auxiliary relay is coupled to a hot line of the one or more hot lines of the auxiliary power connection.

8. The device of claim 1, wherein the data collection and control module is further configured to close or maintained closed the auxiliary relay and open or maintain open the main relay when an outage from the input power connection occurs and power to the input power connection is halted.

9. The device of claim 8, wherein the data collection and control module is further configured open the auxiliary relay and close the main relay when the outage is resolved and power to the input power connection is restored.

10. The device of claim 1, further comprising a housing containing the main relay, auxiliary relay, and data collection and control module.

11. The device of claim 10, wherein the housing is separate from a meter socket.

12. The device of claim 10, wherein the housing further contains a power meter.

13. An electrical power control device, comprising:
a main relay coupled to an input power connection;
a main power connection for transmitting electrical power from the main relay to a disconnect panel;
an auxiliary power connection for transmitting electrical power from the main relay to an auxiliary device;
an auxiliary relay coupled to the auxiliary power connection;
an input current sensor configured to sense an input electrical current flowing through the input power connection;
a main current sensor configured to sense a main electrical current flowing through the main power connection;
an auxiliary current sensor configured to sense a second electrical current flowing through the auxiliary power connection; and
a data collection and control module coupled to the main relay, the auxiliary relay, the input current sensor, the main current sensor, and the auxiliary current sensor, wherein the data collection and control module is configured to selectively open and close the main relay and to selectively open and close the auxiliary relay depending on whether the auxiliary device functions as a current load or a current source.

14. The device of claim 13, wherein the data collection and control module is further configured to open the auxiliary relay when a total current flowing through at least one of the input power connection, the main power connection, or the auxiliary power connection reaches or exceeds a predetermined safety threshold.

15. The device of claim 14, wherein the predetermined safety threshold is between 50 percent and 95 percent of a maximum ampacity rating of the input disconnect.

16. The device of claim 14, wherein the predetermined safety threshold is between 70 percent and 95 percent of a maximum ampacity rating of the input disconnect.

17. The device of claim 13, wherein the data collection and control module further comprises a communication module configured to send information based on data from the input current sensor, the main current sensor, and the auxiliary current sensor to a user device.

18. A method of forming an electrical power control device, the method comprising:
coupling a main relay to an input power connection;
coupling a main power connection to the main relay for electrically connecting to a disconnect panel;
coupling an auxiliary power connection to the main relay for electrically connecting to an auxiliary device;
coupling an auxiliary relay to the auxiliary power connection; and
coupling a data collection and control module to the main relay and to the auxiliary relay such that the data collection and control module is configured to selectively open and close the main relay and to selectively open and close the auxiliary relay depending on whether the auxiliary device functions as a current load or a current source.

19. The method of claim 18, further comprising:
coupling an input current sensor to the input power connection to sense an input electrical current flowing through the input power connection;
coupling a main current sensor to the main power connection to sense a main electrical current flowing through the main power connection; and
coupling the data collection and control module to the input current sensor and the main current sensor such that the data collection and control module can receive data from the input current sensor and the main current sensor.

20. The method of claim 18, further comprising:
coupling an auxiliary current sensor to the auxiliary power connection to sense an auxiliary electrical current flowing through the auxiliary power connection; and
coupling the data collection and control module to the auxiliary current sensor such that the data collection and control module can receive data from the auxiliary current sensor.
